(19) United States
(12) Patent Application Publication
(10) Pub. No.: US 2025/0033312 A1
(43) Pub. Date: Jan. 30, 2025

(54) Methods and Systems for Preparing Blanks for Forming Carriers for Containers

(71) Applicant: Graphic Packaging International, LLC, Atlanta, GA (US)

(72) Inventors: Colin P. Ford, Woodstock, GA (US); David F. Warner, Waynesville, NC (US); Jason C. Anderson, Marietta, GA (US)

(21) Appl. No.: 18/917,321

(22) Filed: Oct. 16, 2024

Related U.S. Application Data
(63) Continuation-in-part of application No. 17/951,199, filed on Sep. 23, 2022, now Pat. No. 12,138,885.
(60) Provisional application No. 63/568,193, filed on Mar. 21, 2024.
(60) Provisional application No. 63/261,582, filed on Sep. 24, 2021.

(51) Int. Cl. B31F 1/00; B65B 17/02

(52) U.S. Cl. CPC B31F 1/0016; B65B 17/025

(57) ABSTRACT

A method for processing at least one blank for forming a carrier for a plurality of containers, the method includes obtaining at least one blank having a central panel with plurality of container openings and at least one container retention tab extending into respective container openings of the plurality of container openings, loading the at least one blank into a blank infeed assembly, moving the at least one blank from the infeed assembly to a blank processing assembly, the blank processing assembly including a forming belt having a plurality of openings extending at least partially therethrough for being aligned with respective container openings of the plurality of containers openings of the at least one blank, and moving the at least one blank to a product engagement portion of the blank processing assembly such that the at least one blank is positioned for engagement with a group of containers.

### CROSS-REFERENCE TO RELATED APPLICATIONS

The present application is a continuation-in-part of U.S. patent application Ser. No. 17/951,199, filed on Sep. 23, 2022, entitled Methods and Systems For Preparing Blanks For Forming Carriers For Containers, which claims the benefit of U.S. Provisional Patent Application No. 63/261,582, filed on Sep. 24, 2021, entitled Methods and Systems For Preparing Blanks For Forming Carriers For Containers. The present application also claims the benefit of U.S. Provisional Patent Application No. 63/568,193, filed on Mar. 21, 2024, entitled Methods and Systems For Preparing Blanks For Forming Carriers For Containers.

### INCORPORATION BY REFERENCE

The disclosures of each of U.S. Provisional Patent Application No. 63/261,582, filed on Sep. 24, 2021, entitled Methods and Systems For Preparing Blanks For Forming Carriers For Containers, U.S. patent application Ser. No. 17/951,199, filed on Sep. 23, 2022, entitled Methods and Systems For Preparing Blanks For Forming Carriers For Containers, and U.S. Provisional Patent Application No. 63/568,193, filed on Mar. 21, 2024, entitled Methods and Systems For Preparing Blanks For Forming Carriers For Containers, are hereby incorporated by reference for all purposes as if presented herein in their entireties.

### BACKGROUND OF THE DISCLOSURE

The present disclosure generally relates to systems and methods of processing blanks for forming carriers, packages, and/or other suitable constructs. More specifically, the present disclosure is directed to methods and systems for processing blanks and carriers formed therefrom.

### SUMMARY OF THE DISCLOSURE

According to one aspect, the disclosure is generally directed to a method for processing at least one blank for forming a carrier for a plurality of containers, the method comprising obtaining at least one blank comprising a central panel having plurality of container openings and at least one container retention tab extending into respective container openings of the plurality of container openings, loading the at least one blank into a blank infeed assembly, moving the at least one blank from the infeed assembly to a blank processing assembly, the blank processing assembly comprising a forming belt having a plurality of openings extending at least partially therethrough for being aligned with respective container openings of the plurality of containers openings of the at least one blank, and moving the at least one blank to a product engagement portion of the blank processing assembly such that the at least one blank is positioned for engagement with a group of containers.

According to another aspect, the disclosure is generally directed to a system for processing at least one blank for forming a carrier for a plurality of containers, the system comprising an upstream end, a downstream end, and a machine direction extending from the upstream end to the downstream end, a blank infeed assembly for moving the at least one blank in the machine direction, and a blank processing assembly, the blank processing assembly comprising a forming belt arranged in a closed path and having a plurality of openings extending at least partially therethrough for being aligned with a respective container opening of a plurality of containers openings of the at least one blank, the blank processing assembly comprising a product engagement portion for being positioned above a group of containers for at least partially receiving a respective container of the plurality of containers through a respective opening of the plurality of container openings of the at least one blank aligned with a respective opening of the plurality of openings of the forming belt.

According to another aspect, the disclosure is generally directed to a blank processing assembly for processing at least one blank for forming a carrier for a plurality of containers, the blank processing assembly comprising a forming belt arranged in a closed path and having a plurality of openings extending at least partially therethrough for being aligned with a respective container opening of a plurality of containers openings of the at least one blank, the blank processing assembly comprising a product engagement portion for being positioned above a group of containers for at least partially receiving a respective container of the plurality of containers through a respective opening of the plurality of container openings of the at least one blank aligned with a respective opening of the plurality of openings of the forming belt.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank for use with systems according to the present disclosure.

FIG. 2 is a perspective view of a container suitable for use with blanks, carriers, and packages formed by the systems and methods of the present disclosure.

FIG. 3 is a perspective view of a system for processing blanks according to an exemplary embodiment of the disclosure.

FIG. 4 is another perspective view of the system of FIG. 3.

FIG. 5 is an enlarged perspective view of a blank infeed assembly of the system of FIG. 3.

FIG. 6 is an enlarged perspective view of a blank processing assembly of the system of FIG. 3.

FIG. 7 is another enlarged perspective view of the blank processing assembly of the system of FIG. 3.

FIG. 7A is an enlarged perspective view of a portion of the blank processing assembly of the system of FIG. 3.

FIG. 8 is a perspective view of a forming wheel of the system of FIG. 3.

FIG. 9 is an enlarged perspective view of a portion of the forming wheel of the system of FIG. 3.

FIG. 10 is a perspective view of a portion of an alternative configuration of a forming wheel.

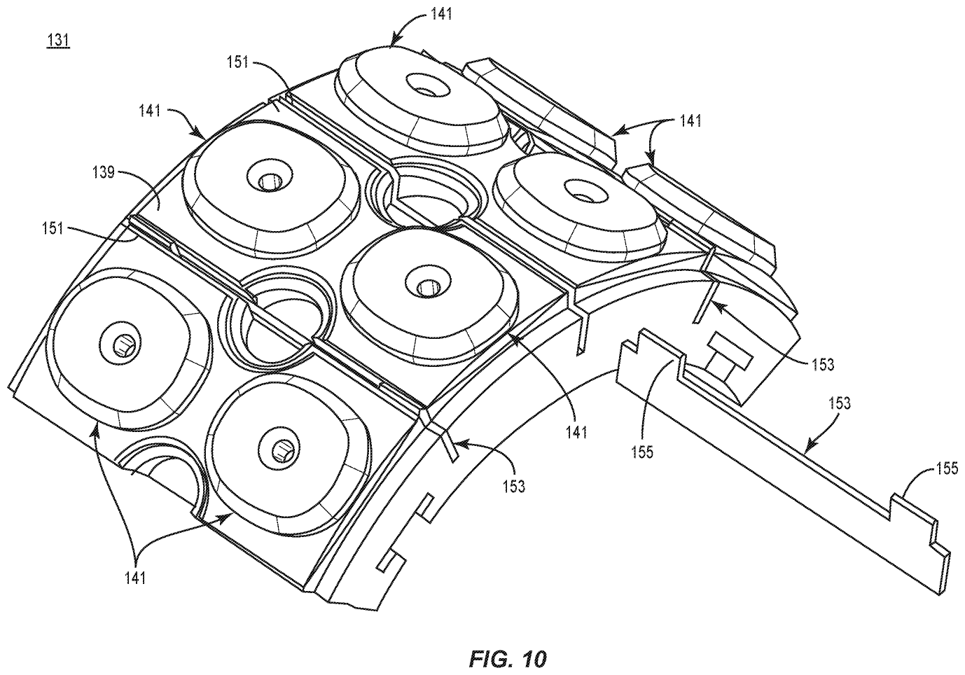

FIG. 11 is a perspective view of the blank of FIG. 1 having been processed by a portion of the system of FIG. 3.

FIG. 12 is a perspective view of a system for processing blanks according to a second exemplary embodiment of the disclosure.

FIG. 13 is another perspective view of the system of FIG. 12.

FIG. 13A is an enlarged perspective view of the forming wheel of the system of FIG. 12.

FIG. 14 is a plan view of an exterior surface of another blank for use with systems according to the present disclosure.

FIG. 15 is a perspective view of a system for processing blanks according to a third exemplary embodiment of the disclosure.

FIG. 16 is another perspective view of the system of FIG. 15.

FIG. 17 is an enlarged perspective view of the system of FIG. 15 near a blank infeed assembly thereof.

FIG. 18 is another enlarged perspective view of the system of FIG. 15 near a blank infeed assembly thereof.

FIG. 19 is an enlarged perspective view of the system of FIG. 15 near a lug assembly thereof.

FIG. 20 is an enlarged perspective view of the system of FIG. 15 near a nick breaking assembly thereof.

FIG. 21 is an enlarged side view of the system of FIG. 15 near a nick breaking assembly thereof.

FIG. 22 is another enlarged perspective view of the system of FIG. 15 near a nick breaking assembly thereof.

FIG. 23 is an enlarged perspective view of the system of FIG. 15 near a downstream portion thereof.

Corresponding parts are designated by corresponding reference numbers throughout the drawings.

### DETAILED DESCRIPTION OF THE EXEMPLARY EMBODIMENTS

The present disclosure generally relates to a system and method of preparing/processing a blank or other construct for further processing and/or for forming carriers for holding products such as containers, e.g., food and beverage containers. The containers can be made from materials suitable in composition for packaging the particular food or beverage item, and the materials include, but are not limited to, glass; plastics such as PET, LDPE, LLDPE, HDPE, PP, PS, PVC, EVOH, and Nylon; and the like; aluminum and/or other metals; or any combination thereof.

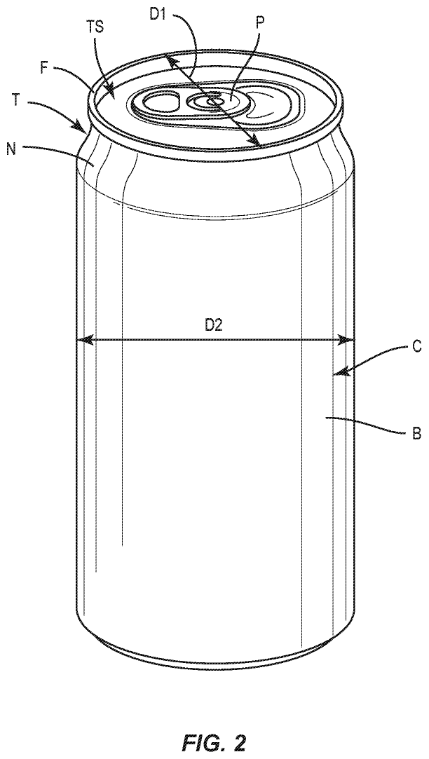

Referring momentarily to FIG. 2, containers for use with the carriers of the present disclosure are illustrated as beverage containers having a lower base portion B, a top portion T generally comprising a neck N that tapers inwardly from the lower base portion, a flange portion F at the top of the neck portion that extends radially outward from the neck portion, and a top surface TS below the flange portion that includes a pull-tab P. In one embodiment, a top and/or bottom end of the container can have diameter D1 of about 66 mm and a central portion of the container can have a diameter D2 of about 202 mm. In another embodiment, a top and/or bottom end of the container can have diameter D1 of about 58 mm and a central portion of the container can have a diameter D2 of about 200 mm. Containers of other sizes, shapes, and configurations, may be held in the carriers without departing from the disclosure. In embodiments, carriers according to the present disclosure can be provided with one or more containers to form a package.

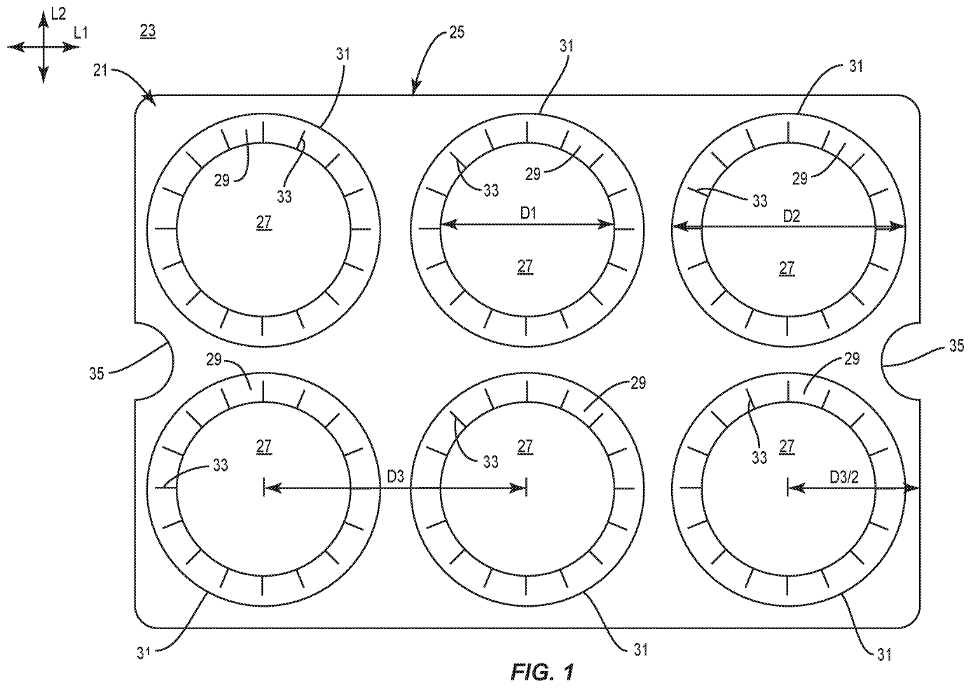

Referring to FIG. 1, an exterior surface 21 of a blank 23 for forming a carrier for holding/supporting/dispensing one or more containers is illustrated. The blank 23, as shown, can have a longitudinal axis L1 and a lateral axis L2, and can include a central panel or top panel 25 with container retention features that include a plurality of container retention openings or container openings 27.

As shown, the container openings 27 can be provided in a column and row arrangement in a number that corresponds to a desired number of containers to be held by the carrier formed from the blank 23. While the top panel 25 is shown having container openings 27 provided in two rows/columns of three openings 27 each, it will be understood that a different number and/or arrangement of container openings 27 can be provided without departing from the disclosure.

The container openings 27 can have a generally circular configuration, with container retention tabs 29 foldably connected to the top panel 25 at respective curved fold lines 31/respective portions of a curved fold line 31 and positioned to extend toward the center of the respective container openings 27. It will be understood that the container retention tabs 29 can be provided in a generally abutting circumferential arrangement, separated at respective oblique lines of weakening 33, though spacing could be provided between adjacent container retention tabs 29 without departing from the disclosure.

While the container retention tabs 29 are illustrated as generally trapezoidal or rectangular elements having free edges facing the centers of the respective container openings 27, it will be understood that one or more of the container retention tabs 29 can have a different configuration or arrangement without departing from the disclosure.

As described herein, the container openings 27 are configured for at least partially receiving respective containers, e.g., a top portion T of a respective container, such that the container retention tabs 29 can be urged upwardly at the respective fold line(s) 31 to extend into a portion of the respective containers, e.g., the flange portion F, to provide a secure engagement between the carrier/top panel 25 and the respective containers.

In this regard, preparation/processing of the blank 23 for formation into a carrier can include one or more of separating adjacent container retention tabs 29, e.g., at the lines of weakening 33, and/or at least partially folding the container retention tabs 29 upwardly at the respective fold line(s) 31 (broadly, “pre-breaking”) in preparation for at least partially receiving the respective containers.

It will be understood that the blank 23 can have a different configuration without departing from the disclosure.

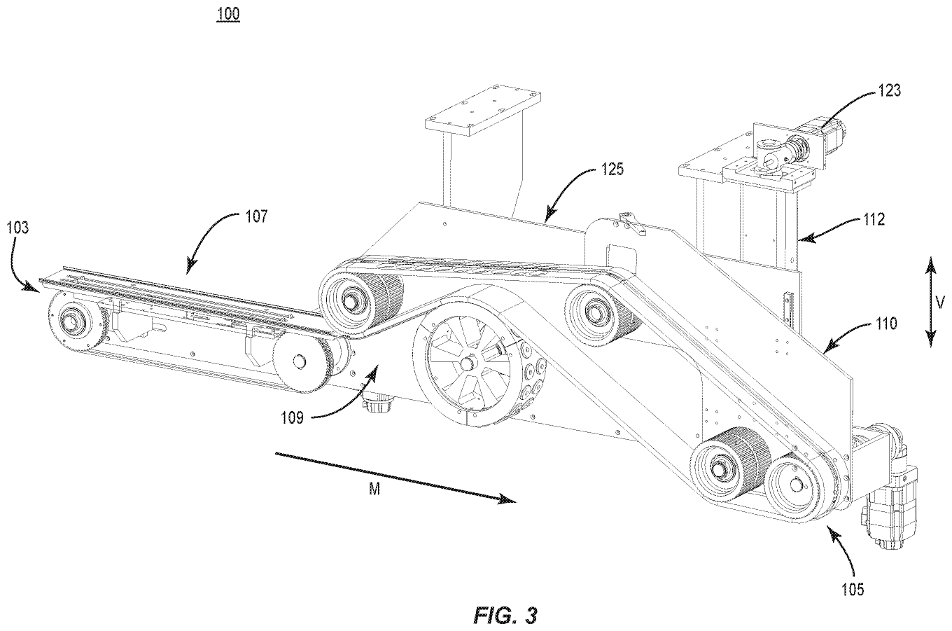

FIG. 3 generally illustrates a first exemplary embodiment of a system 100 for preparing/processing blanks 23 in accordance with the present disclosure. As described herein, the system 100 can be configured to pre-break, e.g., separate adjacent container retention tabs 29, e.g., at the lines of weakening 33 and/or at least partially folding the container retention tabs 29 upwardly at the respective fold line(s) 31 in preparation for at least partially receiving the respective containers. The system 100 can also be configured to separate blanks 23 from one another when fed into the system 100 as a set of at least partially attached blanks 23 and/or pre-breaking the blanks 23 can also include such separation of blanks 23.

The method and system 100 can include a machine frame supporting the various assemblies and components thereof described herein. The machine frame can include one or more of bases, legs, struts, tie bars, platforms, etc., in various arrangements, to provide a supporting structure for the assemblies and components described herein. For example, a machine frame can support such components above a base surface such as a ground or floor, and can provide access at one or more locations for human operators, e.g., to inspect, maintain, and/or otherwise operate the system 100. In one embodiment, the system 100 can be provided without an external frame.

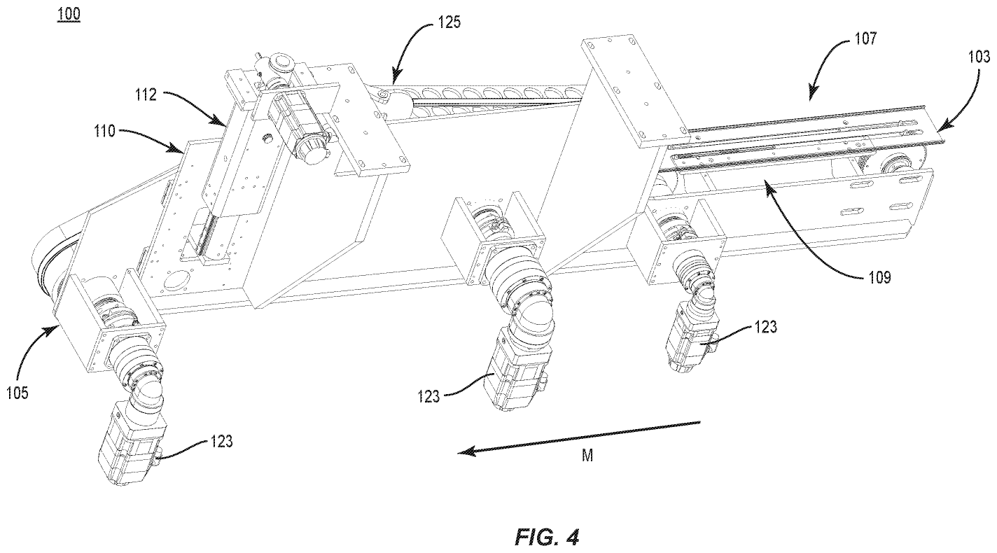

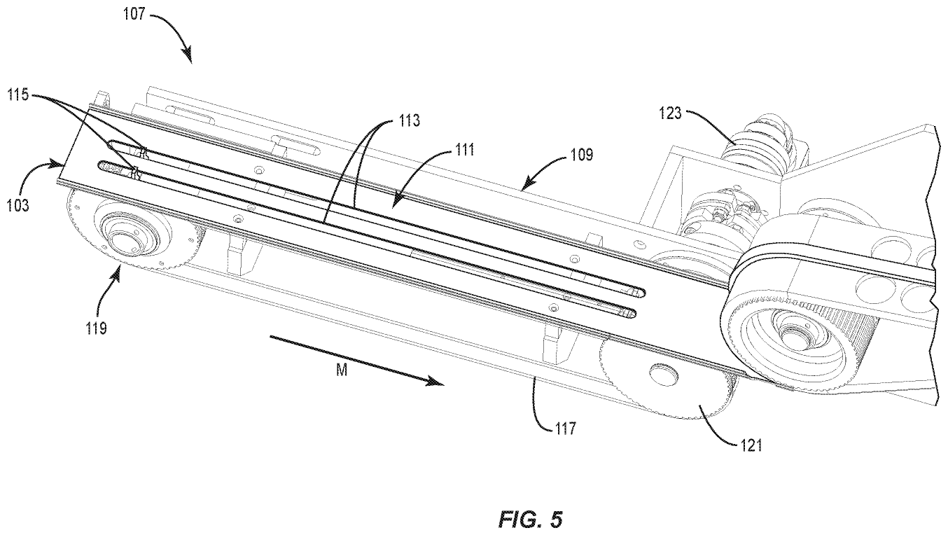

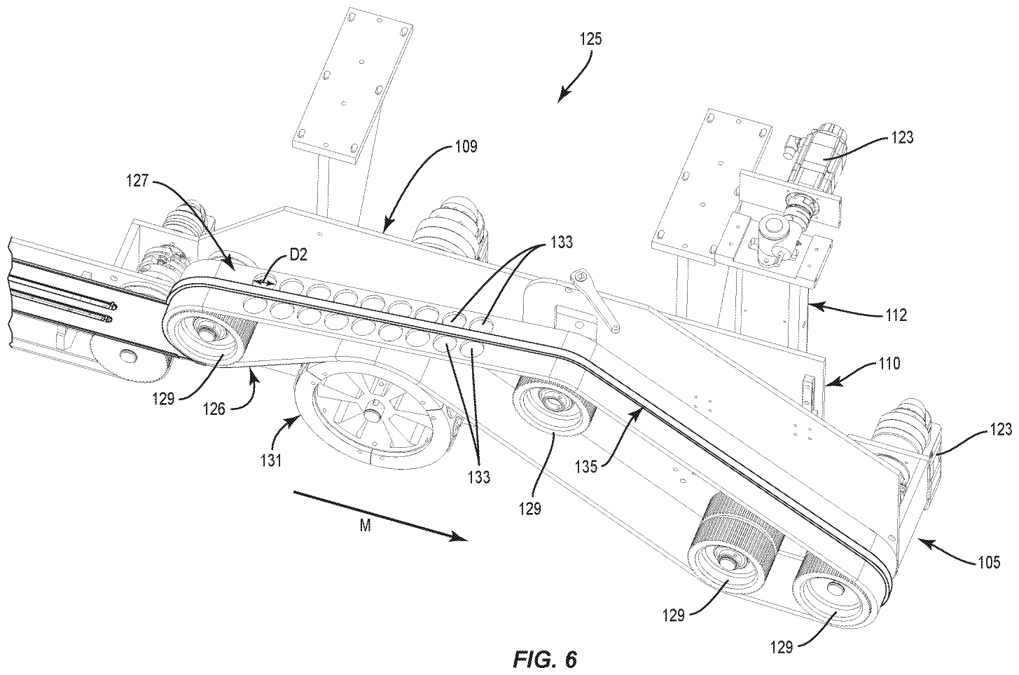

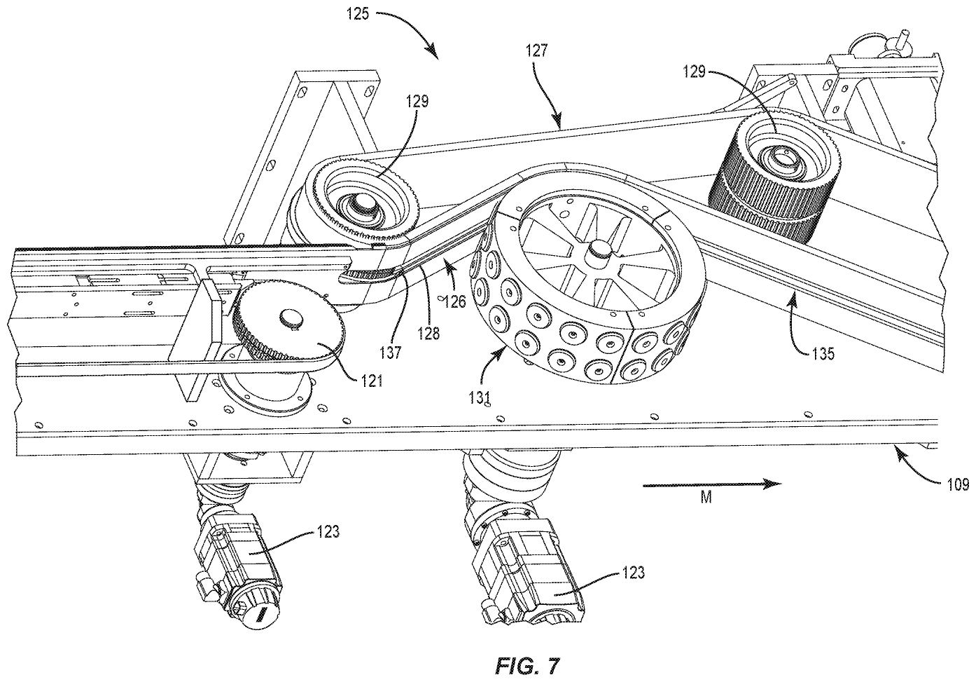

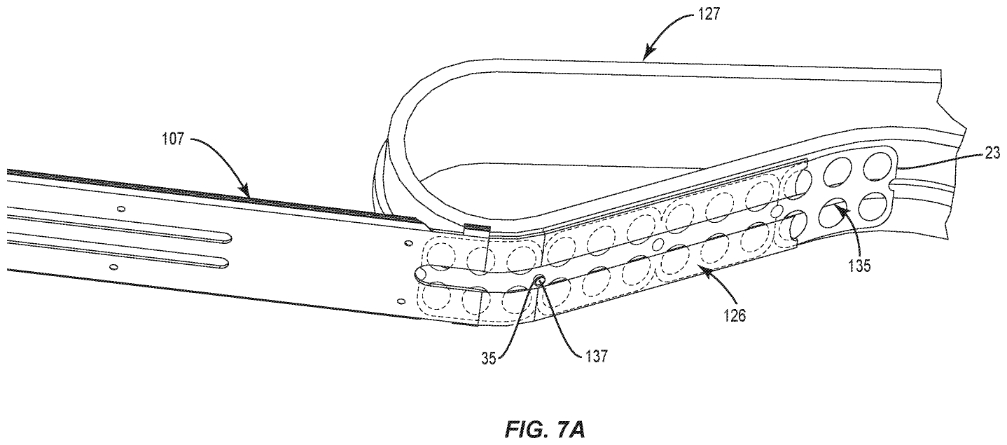

With additional reference to FIG. 4-7A, the blanks 23 can move through the system 100 from an upstream end 103 to a downstream end 105 thereof generally in a downstream direction or machine direction M that defines/is parallel to a downstream direction with regard to the system 100 and such that the blanks 23 are engaged by various portions and components of the system 100. In this regard, an upstream direction with regard to the system 100 is a direction opposite the machine direction M/downstream direction.

The system 100 can include a blank infeed assembly 107 proximate the upstream end 103 thereof for receiving and sequentially distributing blanks 23 in the machine direction M of the system 100. Accordingly, the system 100 can include a feeder mechanism such as a hopper, chute, or other in-line or right-angle distribution mechanism.

As additionally shown, the blank infeed assembly 107 can include a generally vertical base or support 109 (broadly, “first support”) upon which a bedplate 111 is mounted for supporting one or more of the blanks 23 from a feeder mechanism. The bedplate 111, as shown, can be a generally flat, elongate member defining a pair of generally parallel slots 113 therethrough extending at least a portion along the bedplate 111. The slots 113 are positioned to at least partially receive generally upright/upstanding blank engaging lugs 115 that are attached/coupled to a drive belt 117 looped around a first roller 119 and a second roller 121.

One or both of the first roller 119 and the second roller 121 can have an overall configuration and/or one or more surface elements for facilitating engagement with the drive belt 117, e.g., spurs, gears, spokes, treads, knurls, etc. Each of the first roller 119 and the second roller 121 can be rotatably mounted on the support 109 so as to rotate when driven by a rotation source, as described herein. In one embodiment, one or both of the first roller 119 and the second roller 121 can have the form of a gear or gear wheel.

In the illustrated embodiment, the system 100 can be provided with a motor 123 coupled to the second roller 121 with a suitable transmission mechanism, e.g. a transmission shaft, one or more sets of gearing, etc. to apply a rotational force to the roller 121 when activated, e.g., by an electrical signal. While the motor 123 is shown coupled to the roller 121 to cause rotation thereof, and the roller 119 is shown without an accompanying motor, it will be understood that an additional motor can be provided and coupled to the roller 119 to cause rotation thereof upon activation thereof. In one embodiment, a single motor can apply rotation to each of the roller 119, 121.

A motor as described herein can be any type of motor, engine, actuator, or other driving device that operates by converting energy, e.g., electrical energy and/or chemical fuel into a mechanical energy output.

With continued reference to FIGS. 3-7A, a blank processing assembly 125 can be positioned downstream from the blank infeed assembly 107 in the machine direction M. The blank processing assembly 125 can include a ramp 126 positioned adjacent/abutting a downstream end of the bedplate 111. The ramp 126, as shown, can be angled/sloped or otherwise shaped/oriented to extend further downstream along the blank processing assembly 125. In the illustrated embodiment, the ramp 126 is angled upwardly from the blank infeed assembly 107 toward a forming wheel 131, as described further herein.

The ramp 126 can be configured to support one or more of the blanks 23 and can include an elongate slot or track 128 to receive a portion of the blank processing assembly 125 to facilitate movement of the blank(s) 23 downstream in the blank processing assembly 125. While the ramp 126 is shown and described as being positioned downstream from the blank infeed assembly 107/bedplate 111, it will be understood that the ramp 126 can be considered a downstream portion of the blank infeed assembly 107/bedplate 111 without departing from the disclosure.

The blank processing assembly 125, as shown, can include a forming belt 127 extending around, e.g., forming an outer perimeter, about a series of rollers 129 such that the forming belt 127 is arranged in a closed path.

The rollers 129 can have one or more features for engaging the forming belt 127, e.g., spurs, gears, spokes, treads, knurls, etc. The rollers can be configured to rotate in a common direction, e.g., counterclockwise, to cause the forming belt 127 disposed thereabout in a desired direction. As also shown, one or more of the rollers 129 can be provided with a motor 123 to apply a rotational force thereto when activated, e.g. As described further herein, the rollers 129 can be driven and the forming belt 127 can be caused to move such that a portion of the forming belt 127 proximate a forming wheel 131 can generally move in the machine direction M.

The forming belt 127, as shown, can be a generally flat member having a plurality of openings 133 formed therethrough. The forming belt 127 can be formed of a material suitable to withstand applied tension and/or engagement with the respective rollers 129. In one embodiment, the forming belt 127 can include one or more of polymeric materials, composite materials, and metallic materials. In one embodiment, the forming belt 127 can include one or more reinforcing members, e.g., embedded structures, binders, braids, etc.

As described further herein, the openings 133 in the forming belt 127 can be formed in with a diameter/arrangement corresponding to that of the container openings 27 and container retention tabs 29 of the blank 23. The openings 133 can extend at least partially through a thickness of the forming belt 127, e.g., such that respective recesses are formed. In the illustrated embodiment, the openings 133 in the forming belt 127 can have the diameter D2 that corresponds to a distance from a curved fold line/portion of the curved fold line 31 to a diametrically opposed portion of the curved fold line/curved fold line 31 of the blank 23.

The aforementioned arrangement of the forming belt 127 is such that that when the forming belt 127 is arranged in a generally planar arrangement above a respective blank 23, respective openings 133 in the forming belt 127 can be aligned with the container openings 27 in the blank 23. While openings 133 are shown formed along a portion of the belt 127 in the illustrated embodiment, it will be understood that the openings 133 can be provided along a longer length of the forming belt 127 without departing from the disclosure.

A transport band 135 can be wrapped about an outward-facing surface of the forming belt 127, and as shown, can be positioned between rows of the openings 133 in the forming belt. One or more blank engaging members, e.g., lugs 137, can be coupled to the transport band 135 so as to follow the path of the forming belt 127 when the motors 123 are activated. In this regard, the lugs 137 are at least partially supported on the belt 127 via the transport band 135. It will be understood that the transport band 135 can have a different configuration, e.g., cables, belts, plates, rods, etc. In one embodiment, the transport band 135 can be formed of a stretchable material, e.g., an elastomeric material or otherwise elastically deformable and/or resilient material.

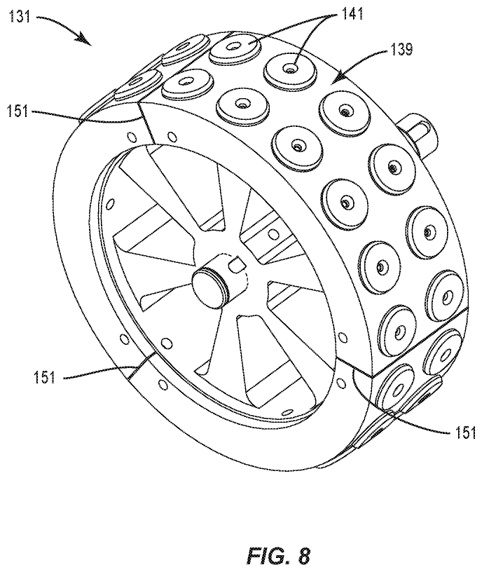

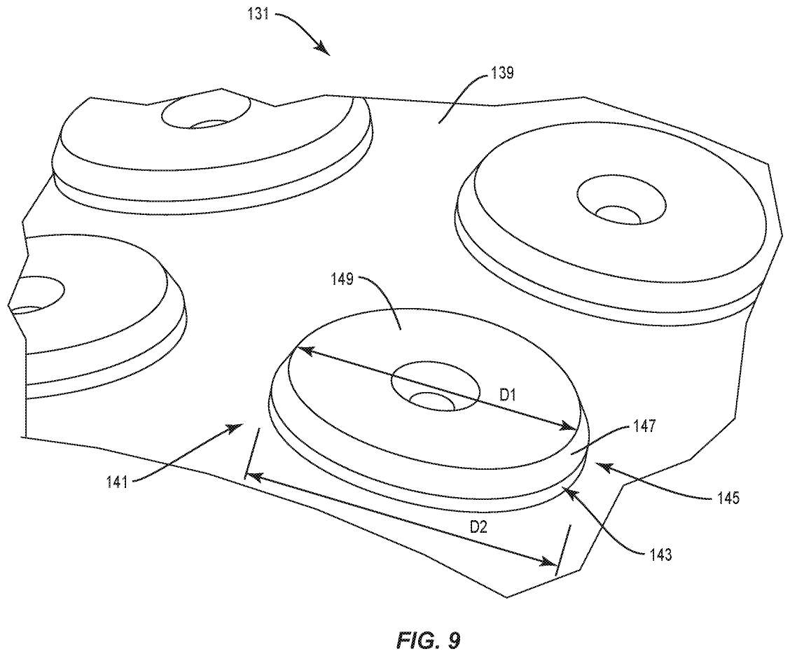

With continued reference to FIGS. 3-7A, and with additional reference to FIGS. 8 and 9, the forming wheel 131 can be rotatably mounted on the vertical support 109 and can be provided with a motor 123 and accompanying mechanical transmission/gearing to apply a rotational force thereto when activated. As shown, the forming wheel 131 can have an outer blank engaging surface 139 along the circumference of the forming wheel 131 that defines a plurality of forming members 141. As shown, one or more slots 151 can be defined along the forming wheel 131 interrupting the blank engaging surface 139. In some embodiments, the slots 151 can be for at least partially receiving cutting members, as described further herein.

The forming members 141 as shown, can be generally cylindrical protrusions defined along the blank engaging surface 139 and having a body portion 143 defining a diameter D2 generally corresponding to the diameter D2 of the container openings 27/container retention tabs 29 in the blank 23 and the diameter of the openings 133 in the forming belt 127. As also shown, the forming members 141 can have distal/free end portions 145 that taper to a diameter smaller than that of D2. In the illustrated embodiment, the distal end portion 145 of the forming members 141 can have a beveled surface 147, e.g., an angled or sloped surface having the general profile of a conic section, extending from an end of the body portion 143 to a distal end surface 149 of the respective forming member 141.

The distal end surface 149 of the respective forming members 141 can define a diameter generally corresponding to the diameter D1 between free edges of diametrically opposed tabs 29 across the container openings 27 of the blank 23. In the regard, the diameter of the forming members 141 transitions from the diameter D1 at the distal end surface 149 to the diameter D2 at the body portion 143 across the beveled surface 147. As described further herein, the distal end surface 149, the beveled surface 147, and/or the outer surface of the body portion 143 can be positioned and configured to contact respective portions of the blank 23. One or more of the forming members 141 can have a different configuration without departing from the disclosure. For example, one or both of the beveled surface 147 and/or the outer surface of the body portion 143 can have one or more intersecting planar surfaces/angled surfaces/segmented surfaces/further beveled surfaces therealong.

Turning to FIG. 9, an alternative configuration of the forming wheel 131 is generally designated 131A. The forming wheel 131A can include the slots 151 interrupting the blank engaging surface 139 and having a radial depth sufficient to at least partially receive respective cutting members 153 so as to position the cutting members 153 at least partially protruding from the blank engaging surface 139. The cutting members 153, as shown, can include one or more nick-breaking edges 155 for separating joined blanks 23, as described further below. In one embodiment, the slots 151 can be formed along one or more generally continuous portions of the blank engaging surface 139. In other embodiments, the forming wheel 131 can include multiple circumferential sections that are assembled to provide the blank engaging surface 139, with the slots 151 defined between adjacent sections of the forming wheel 131/blank engaging surface 139. It will be understood that the cutting members 153 can be provided in one or more of the respective slots 151 of the forming wheel 131 to provide the configuration described above.

As described herein, preparation/processing of the blank 23 for formation into a carrier with the system 100 can include one or more of separating adjacent container retention tabs 29, e.g., at the lines of weakening 33, and/or at least partially folding the container retention tabs 29 upwardly at the respective fold line(s) 31 in preparation for at least partially receiving the respective containers. It will be understood that the system 100 can have a different configuration than that described above in order to achieve the disclosed preparation/processing of the blanks 23.

It will also be understood that the system 100 described above can be adjusted to accommodate different types/arrangements/dimensions of blanks 23, e.g., so as to minimize the number of replacement/change parts involved with utilizing the system 100 for different blanks, e.g., to streamline operations and minimize downtime. For example, one or more adjustment controls, e.g., levers, knobs, toggles, buttons, tools (such as wrenches), can be coupled to one or more tolerance adjusting features of the system 100 (e.g., nuts, bolts, screws, clamps, vices, jacks, lifts, cranks, wheels, etc.).

As another example, a portion of the blank processing assembly 125, e.g., one or more of the rollers 129 and the forming wheel 131, as shown, can be mounted on a vertical support/base 110 (broadly, “second support”) that is adjustable relative to the vertical support/base 109 supporting the remainder of the blank processing assembly 125 so as to change a distance between the forming belt 127 and the forming wheel 131. As shown, a lifting mechanism 112, e.g., a lift or jack (e.g., a hydraulic or pneumatic lift or jack, or other type of lift or jack) can be operably engaged with the vertical support/base 109 so as to lift or raise the vertical support/base 110 relative to the vertical support/base 109 in a vertical direction V, e.g., to bring the forming belt 127 into closer or further engagement with respect to the blank engaging surface 139 of the forming wheel 131 and/or other portions of the blank processing assembly 125 such as the ramp 126. In one embodiment, such lifting mechanism 112 can be driven by a motor 123.

With reference again to FIGS. 1-7A, a method of preparing blanks 23 with the system 100 according to an exemplary embodiment of the disclosure will be generally described.

One or more blanks 23 can be inserted into the blank infeed assembly 107, e.g., via placement onto the bedplate a feeder mechanism as described above. It will be understood that the system 100 can be configured to process a series of blanks 23 joined together at respective lateral lines of weakening. Such input of multiple successive blanks 23 into the system 100 can streamline loading operations, reduce alignment errors, etc.

As shown in FIG. 1, each container opening 27 can be spaced apart a longitudinal distance D3, e.g., corresponding to a distance in the machine direction M. The distance between container retention openings 27 adjacent a lateral edge of the blanks 27 and the lateral edge, e.g., at the line of weakening 37, in one embodiment, can be D3/2. In this regard, the distance between the general center of a container retention opening 27 adjacent a trailing edge of a blank 23 and that of a leading container retention opening 27 adjacent a leading edge of a next successive blank 23 can be D3 so that a longitudinal distance between successive container retention openings 23 within and across all adjacent joined blanks 23 can be D3. Such arrangement of the blanks 23/container openings 27 formed therein can also facilitate later engagement of the blank 23/carrier formed therefrom with products, as described further herein.

As each blank 23 reaches a generally planar engagement with the bedplate 111, e.g., so that an interior or downward-facing surface of the blank 23 is in at least partial face-to-face contact with the bedplate 111, the blank engaging lugs 115 can travel in a curved path about the roller 119 and positioned to extend upwardly through a pair of the container openings 27 at a leading edge of a respective blank 23. Further movement of the blank engaging lugs 115 through the respective slots 113 along the bedplate 111 in the machine direction M can cause the blank 23 to travel, e.g., through sliding engagement with the bedplate 111, in the machine direction M.

It will be understood that multiple pairs of blank engaging lugs 115 can be attached to the drive belt 117 in spaced apart relation along the machine direction M. In one embodiment, pairs of blank engaging lugs 115 can be spaced apart along the drive belt 117 a distance sufficient for a pair of blank engaging lugs 115 to extend upwardly through a respective pair of container openings 27 at a leading edge of each successive blank 23 of a plurality of attached blanks 23. In other embodiments, pairs of blank engaging lugs 115 can be spaced apart along the drive belt 117 a different distance, e.g., so that a pair of blank engaging lugs 115 are positioned to upwardly through a respective pair of container openings 27 at a leading edge of less than each successive blank 23 of a plurality of attached blanks 23. In some embodiments, the blank engaging lugs 115 can be positioned to extend upwardly through respective container openings 27 other than those at a leading edge of the respective blank 23.

Further driving of the drive belt 117 by the rollers 119, 121 causes the blank(s) 23 to move in the machine direction M and approach the ramp 126 and the blank processing assembly 125. Upon entering the ramp 126 (and upon activation of the motors 123 associated with the blank processing assembly 125), the forming belt 127 and the transport band 135 carried thereon can move into an alignment with a respective blank 23 slidably moving along the ramp 126 such that the blank 23 is positioned between the forming belt 127 and the ramp 126. In such alignment, openings 133 in the forming belt 127 can be positioned to overlie/align with the respective container openings 27 in the blank 23, e.g., such that a passage from the container openings 27 in the blank 23 to/through the openings 133 in the forming belt 127 is provided.

Such alignment of an aforementioned portion of the forming belt 127 with the blank 23 can also position a lug 137 carried on the transport band 135 to extend through the track 28 in the ramp 26 for at least partial insertion through/into at least the respective recess 35 of a respective blank 23 to further move the blank(s) 23 along the ramp 126.

Such action of the transport band 135/lug 137 can move the blank 23 into engagement with the forming wheel 131. As the forming wheel 131 rotates in the clockwise direction, the blank 23 and forming belt 127/transport band 135 positioned thereon can at least partially wrap/contour about the outer blank engaging surface 139 of the forming wheel 131 such that the blank 23 is positioned between the forming belt 127 and the forming wheel 131.

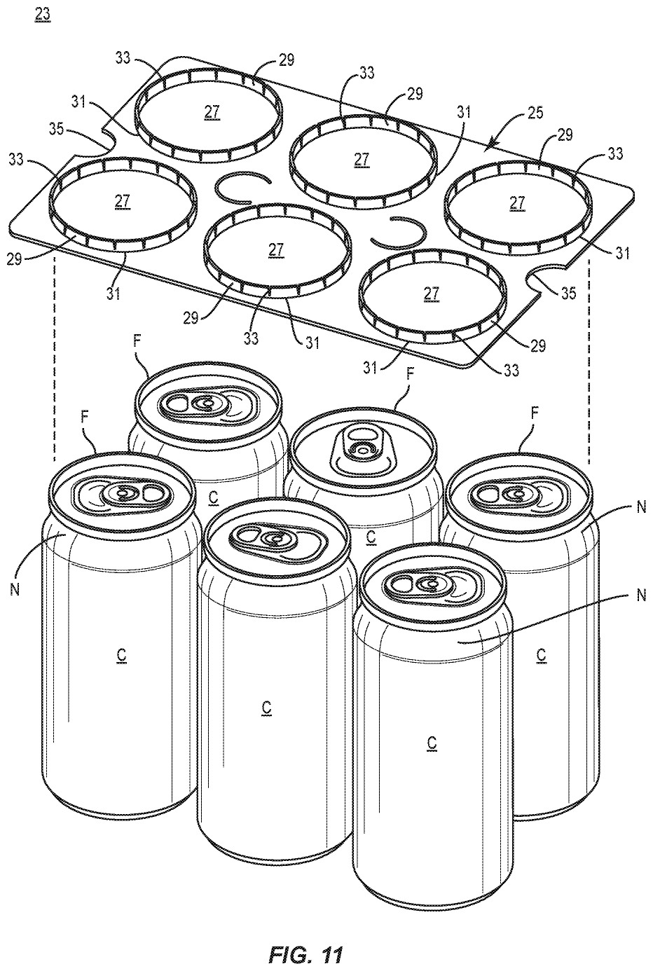

In this arrangement, the forming members 141 extending outwardly from the forming wheel 131 can be positioned to extend through the respective container openings 27 in the blank 23 and at least partially into the openings 133 in the forming belt 127 thereabove. As a forming member 141 enters/extends through a respective container opening 27, the container retention tabs 29 can be contacted by the beveled surface 147 of the forming member 141 and urged to fold at least partially upwardly at respective curved fold lines 31/portions thereof. Such movement of the container retention tabs 29 can also cause respective adjacent container retention tabs 29 to at least partially separate from one another at respective oblique lines of weakening 33. The thickness of the forming belt 127/openings 133 therein can provide clearance for the container retention tabs 29 of the blank 23 to separate/extend upwardly as described above. An example of a blank 23 that has been pre-broken in such a manner is illustrated in FIG. 11.

In some embodiments, the pre-broken blanks 23 can be maintained in at least partial engagement with the forming belt 127 via frictional engagement of the container retention tabs 29 and the portions of the forming belt 127 defining the respective container openings 27.

In one embodiment, the cutting members 153 can be positioned protruding from the outer blank engaging surface 139 of the forming wheel 131 or 131A so as to be positioned to cut/break the line of weakening between a leading blank 23 (broadly, “first blank”) and a next successive/trailing blank 23 (broadly, “second blank”) when the blanks 23 are moved/passed over the forming wheel 131 or 131A. In this regard, the blanks 23 can be aligned relative to the movement of the system 100 such that the lines of weakening between successive blanks 23 are generally aligned with the cutting members 153/slots 151 associated with the forming wheels 131, 131A. In other embodiments, for example, configurations of the system 100 in which a forming wheel is provided without cutting members, successive blanks 23 can be separated via tension along a respective series of blanks 23 upon engagement with the forming wheels 131, 131A as described above.

Each blank 23 can thus be processed/pre-broken and separated from an adjacent blank 23 as it travels across the forming wheel 131. Such processing of the blanks 23 can facilitate later attachment of the blanks 23/carriers formed therefrom to respective containers. In this regard, the blanks 23 can be passed over the forming wheel 131 and applied directly to product containers or moved further downstream for such purpose, e.g., to a product engagement station. In one embodiment, the blanks 23 processed by the system 100 can be wrapped, stacked, packaged, otherwise prepared for transport/shipping.

In this regard, a downstream portion of the blank processing assembly 125 can form a product engagement portion 157 of the blank processing assembly 125/system 100 in which the one or more blanks 23 processed by the blank processing assembly 125 can be positioned/readied to be positioned over a series of products, e.g., containers C. Accordingly, the product engagement portion 157 of the blank processing assembly 125/system 100 can be positioned over a product conveyor or product grouping area such that the blanks 23 can be lowered onto a respective grouping of containers C. A pre-broken blank 23 is illustrated as positioned over and ready for engagement with a group of containers C in FIG. 11. In some embodiments, the pre-broken blanks 23 can have the configuration of a carrier, and can be provided with one or more containers C as a package.

In addition to the multiple streamlined operations performed by the system 100 to prepare the blanks 23 as described above, in embodiments in which multiple joined blanks 23 are processed by the system 100, such separated blanks 23 can exit the system 100/forming wheel 131 in a spacing such that a generally uniform longitudinal distance D2 can be provided between successive container retention openings 27 within and across all adjacent blanks 23 so that products, e.g., beverage containers C, can be transported/conveyed toward the processed blanks 23 in a generally uniform arrangement, e.g., without the need for product grouping or spacing to form specialized groups corresponding in number to the container openings 27 of each blank 23.

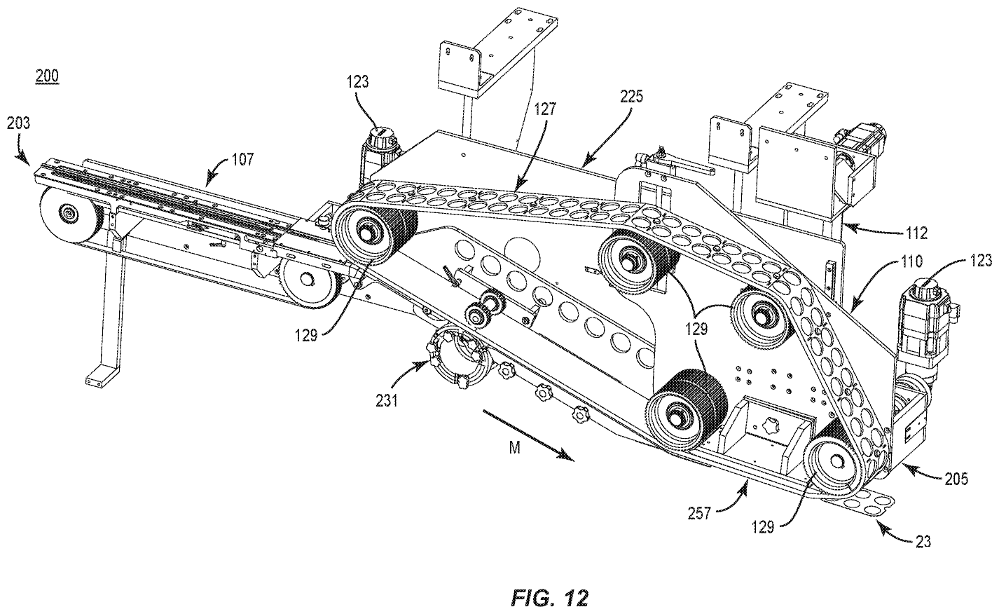

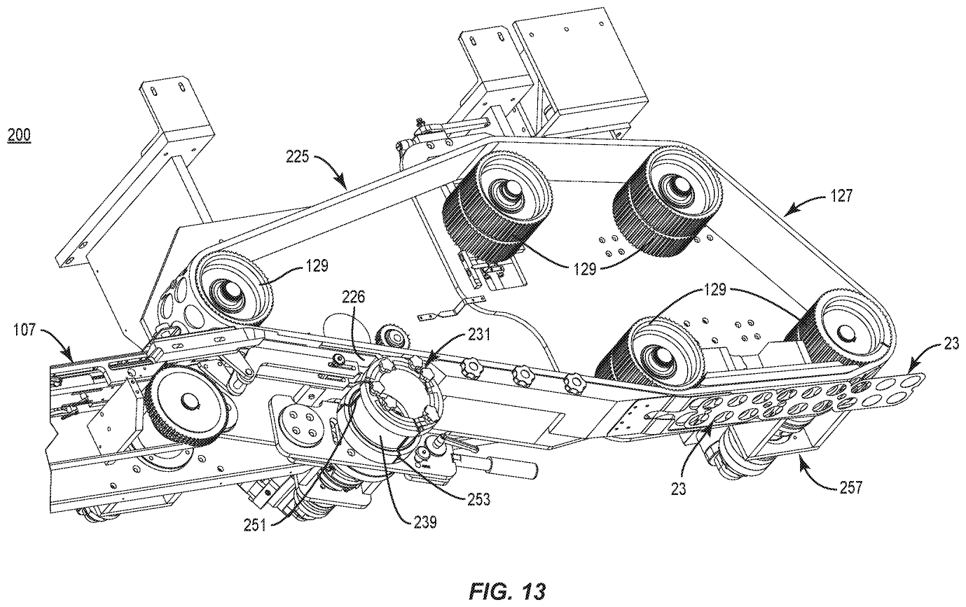

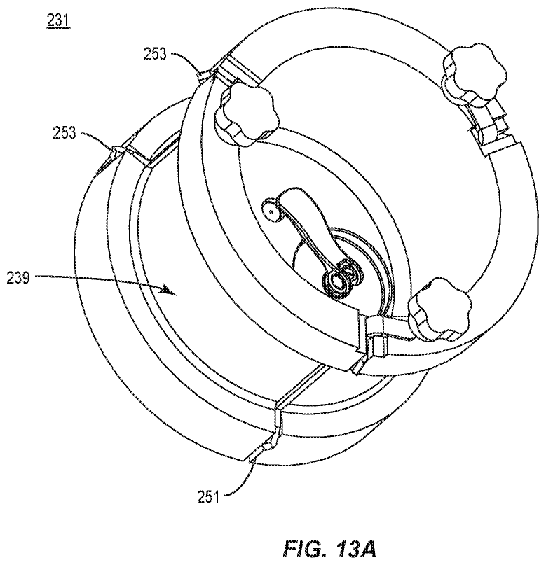

Turning to FIGS. 12, 13, and 13A, a system for preparing preparing/processing blanks 23 according to a second exemplary embodiment of the present disclosure is generally designated 200. The system 200 can have one or more features that are the same or similar to those described above with respect to the system 100, and like or similar features are designated with like or similar reference numerals.

As shown, the system 100 can have an upstream end 203 and a downstream end 205, the blank infeed assembly 107 proximate the upstream end 203, and a blank processing assembly 225 downstream from the blank infeed assembly 107. One or more motors 123 can be provided to rotationally drive one or more respective rollers of the respective blank infeed assembly 107 and/or blank processing assembly 225 as described above with respect to the system 100.

The blank processing assembly 225 can include a forming belt 227 that is generally similar to the forming belt 227 described above, e.g., a generally flat and looped member having the openings 133 extending to a depth at least partially through the forming belt 227. However, in the illustrated embodiment, the forming belt 227 can be provided without a transport band, and can instead be configured to at least partially receive or otherwise support one or more blank engaging members, e.g., the lugs 137.

In some embodiments, the forming belt 227 can be configured to receive/support lugs 137 at selected positions along the belt 227 such that a desired arrangement/interval of lugs 137 can be positioned along the belt 227 for engaging blanks 23 of different sizes and configurations.

The blank processing assembly 225 can further include a ramp 226 sloping generally downwardly from a downstream end portion of the blank infeed assembly 107 for receiving and moving blanks 23 along the blank processing assembly 225. In some embodiments, the ramp 226 can define one or more tracks for receiving a portion of the blank processing assembly 225, e.g., lugs, etc.

The ramp 226, as shown, extends generally obliquely downwardly from the blank infeed assembly 107 toward a forming wheel 231 and/or product engagement portion 257 of the blank processing assembly 225. The ramp 226 can be positioned in generally parallel arrangement with a portion of the forming belt 227, and can have a discontinuity along which a forming wheel 231 can at least partially intersect or abut the path of travel of the blank 23.

The forming wheel 231 can be rotatably mounted on the vertical support 109 and can be provided with a motor, such as a motor 123, and accompanying mechanical transmission/gearing to apply a rotational force thereto when activated. The forming wheel 231 has an outer blank engaging surface 239 along the circumference of the forming wheel 231. One or more slots 251 can be positioned interrupting the blank engaging surface 239 and having a radial depth sufficient to at least partially receive respective cutting members 253 so as to position the cutting members 253 at least partially protruding from the blank engaging surface 239.

The cutting members 253 can include one or more nick-breaking edges for separating joined blanks 23, as described further below. In some embodiments, cutting members or nick breaking edges can be formed as protrusions from the blank engaging surface 239 of the forming wheel 231.

In some embodiments, the forming wheel 231 can have the configuration of one of the forming wheels 131, 131A without departing from the disclosure.

According to one exemplary embodiment, the system 200 can receive one or more blanks 23 at the upstream end 203 thereof, e.g., at the blank infeed assembly 107, and proceed downstream through the blank infeed assembly 107 in the manner described above with respect to the system 100. Such activation and operation of the system 200 can include the activation of one or more of the motors 123.

Upon entering the ramp 226, the forming belt 227 can move into an alignment with a respective blank 23. In such alignment, openings 133 in the forming belt 127 can be positioned to overlie/align with the respective container openings 27 in the blank 23, e.g., such that a passage from the container openings 27 in the blank 23 to/through the openings 133 in the forming belt 227 is provided.

Such alignment of an aforementioned portion of the forming belt 227 with the blank 23 can also position a lug 137 carried on the forming belt 227 to extend into and/or through a track in the ramp 226 for at least partial insertion through/into at least the respective recess 35 of a respective blank 23 to further move the blank(s) 23 along the ramp 226.

Such movement of the blank(s) 23 along the ramp 226 can move the blank(s) 23 into engagement with the forming wheel 231 such that the blank 23 is positioned between the forming belt 227 and the forming wheel 231. As the forming wheel 231 rotates in the clockwise direction, the cutting members 253 can be positioned protruding from the outer blank engaging surface 239 of the forming wheel 231 so as to be positioned to cut/break the line of weakening between a leading blank 23 and a next successive/trailing blank 23 when the blanks 23 are moved/passed over the forming wheel 231. In this regard, the blanks 23 can be aligned relative to the movement of the system 200 such that the lines of weakening between successive blanks 23 are generally aligned with the cutting members 253/slots 251 associated with the forming wheel 231.

Each blank 23 can thus be separated from an adjacent blank 23 as it travels across the forming wheel 231. Such processing of the blanks 23 can facilitate later attachment of the blanks 23/carriers formed therefrom to respective containers. In this regard, the blanks 23 can be passed over the forming wheel 231 and applied directly to product containers or moved further downstream for such purpose, e.g., to a product engagement station. In one embodiment, the blanks 23 processed by the system 200 can be wrapped, stacked, packaged, otherwise prepared for transport/shipping.

In this regard, a downstream portion of the blank processing assembly 225 can form a product engagement portion 257 of the blank processing assembly 225/system 200 in which the one or more blanks 23 processed by the blank processing assembly 225 can be positioned/readied to be positioned over a series of products, e.g., containers C. Upon engagement with a grouping of containers C, the container retention tabs 29 of the respective blanks 23 can at least partially separate from one another at respective oblique lines of weakening 33 and fold at least partially upwardly at the respective fold line 31 into the configuration shown in FIG. 11.

In the illustrated embodiment, one or more portions of the blank processing assembly 225 can have an increased length in the machine direction M. For example, in some embodiments, the ramp 226 can have a generally increased length in the machine direction M and a disposition at a shallow oblique angle so as to permit processing of a blank 23 or a series of blanks 23 at generally longer lengths without a trailing end thereof becoming entangled/curved about the portion of the forming belt 227 in curved engagement with the roller 129. In some embodiments, the product engagement portion 257 can have a generally increased length in the machine direction M, e.g., to facilitate disengagement of the lugs 137 from the respective blanks 23 at the downstream end 203 of the system 200. In some embodiments, the portion of the forming belt 227 that curves about the roller 129 at the downstream end 203 of the system 100 can extend upwardly and rearwardly therefrom so as to facilitate such disengagement of the lugs 137 from the respective blanks 23.

In this regard, the system 200 can be configured to prepare/process blanks 23 with advantages similar to those described above with respect to the system 100.

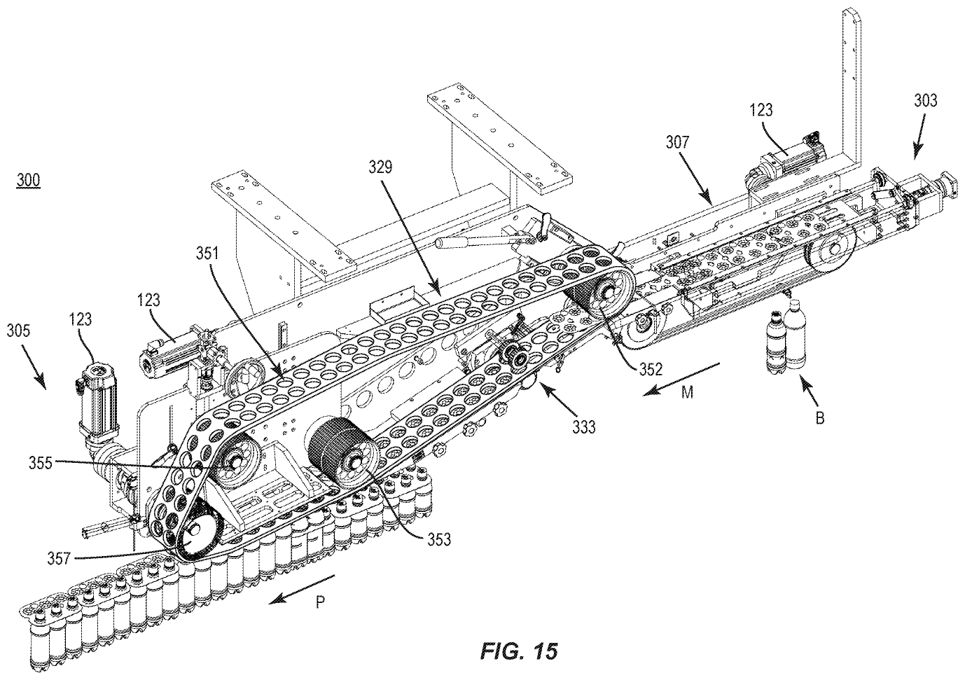

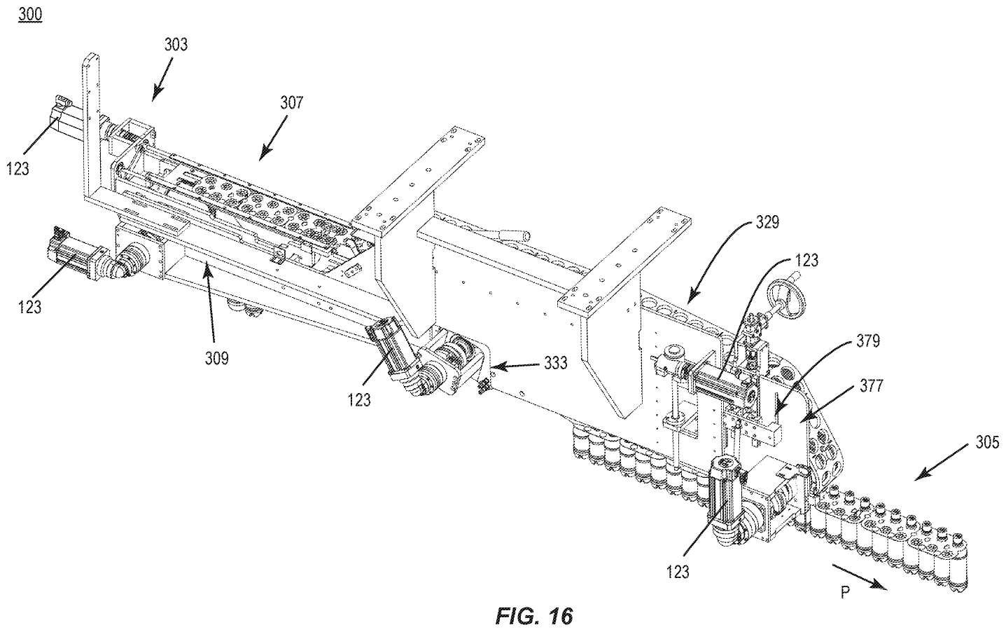

Turning to FIGS. 15 and 16, a method and system for preparing preparing/processing blanks and/or attaching such blanks to containers according to a third exemplary embodiment of the present disclosure is generally designated 300. The method and system 300 can have one or more features that are the same or similar to those described above with respect to the systems 100, 200 and like or similar features are designated with like or similar reference numerals.

The method and system 300 can include a machine frame supporting the various assemblies and components thereof described herein. The machine frame can include one or more of bases, legs, struts, tie bars, platforms, etc., in various arrangements, to provide a supporting structure for the assemblies and components described herein. For example, a machine frame can support such components above a base surface such as a ground or floor, and can provide access at one or more locations for human operators, e.g., to inspect, maintain, and/or otherwise operate the system 300. In one embodiment, the system 300 can be provided without an external frame.

Various components of the system 300 can be provided with motors 123 for effecting a driving force thereupon. It will be understood that such motors 123 can be independently controlled or configured for networked operation, for example, through one or more controllers, processors implementing instructions on non-volatile memory, etc. One or more of the motors 123 can have a different configuration and/or a different arrangement of motors can be provided without departing from the disclosure. It will be understood that various motors described herein can be provided with a suitable intermediate transmission for effecting motion of various components of the system 300, though one or more of the motors 123 can be configured to directly drive such components without a transmission without departing from the disclosure.

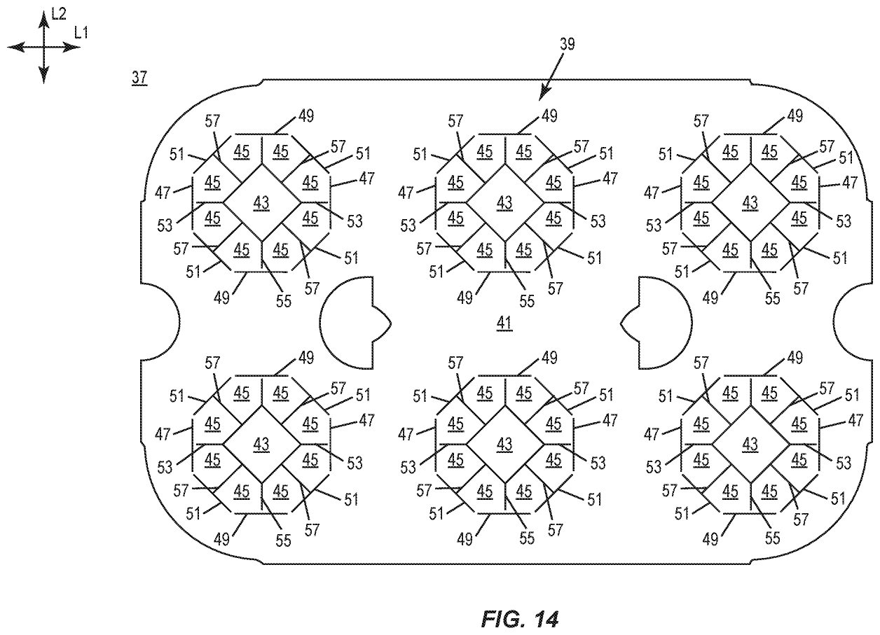

As described herein, the system 300 can be for preparing/processing blanks 37. As shown in FIG. 14, an exterior surface 39 of a blank 37 for forming a carrier for holding/supporting/dispensing one or more containers B is illustrated. The blank 37, as shown, can have a longitudinal axis L1 and a lateral axis L2, and can include a central panel or top panel 41 with container retention features that include a plurality of container retention openings or container openings 43.

As shown, the container openings 43 can be provided in a column and row arrangement in a number that corresponds to a desired number of containers B to be held by the carrier formed from the blank 39. While the top panel 41 is shown having container openings 43 provided in two rows/columns of three openings 43 each, it will be understood that a different number and/or arrangement of container openings 43 can be provided without departing from the disclosure.

The container openings 43 can have a generally circular or polygonal, e.g., octagonal, configuration, with container retention tabs 45 foldably connected to the top panel 41 at respective lateral fold lines 47, longitudinal fold lines 49, and oblique fold lines 51. In the illustrated embodiment, adjacent container retention tabs 45 can be at least partially separable from one another at respective lateral lines of weakening 53, longitudinal lines of weakening 55, and oblique lines of weakening 57.

The container retention tabs 45 are positioned to extend toward the center of the respective container openings 43. While the container retention tabs 45 are illustrated as generally polygonal elements having free edges facing the centers of the respective container openings 43, it will be understood that one or more of the container retention tabs 45 can have a different configuration or arrangement without departing from the disclosure.

As described herein, the container openings 43 are configured for at least partially receiving respective containers B, e.g., a top portion of a respective container B, such that the container retention tabs 45 can be urged upwardly at the respective fold line(s) 47, 49, 51 to extend into a portion of the respective containers B, e.g., a flange portion, to provide a secure engagement between the carrier/top panel 41 and the respective containers B.

It will be understood that the blank 37 can have a different configuration without departing from the disclosure.

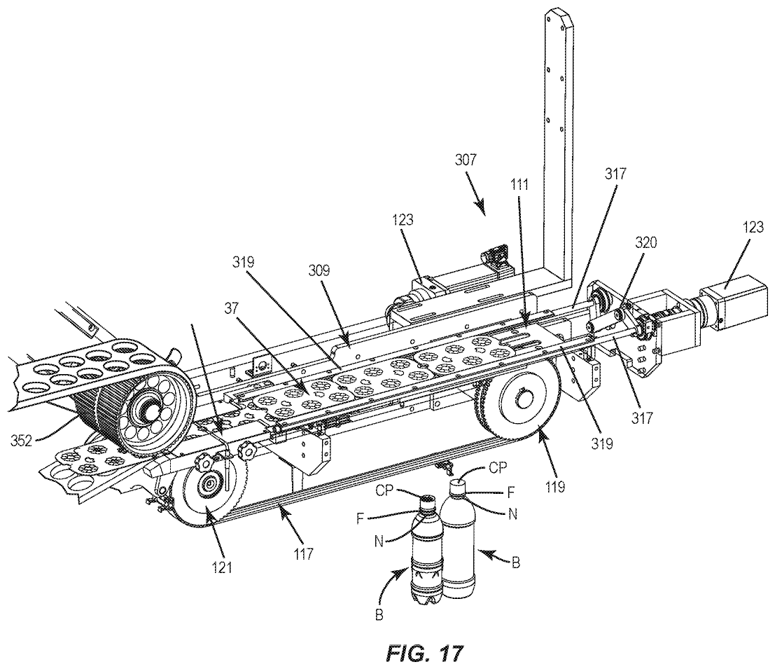

Referring momentarily to FIG. 17, containers B for being received by the blanks 37 and carriers formed therefrom can be bottles, e.g., plastic bottles formed of polyethylene terephthalate (PET) or another polymer, and having upper portions that include an at least partially tapered neck portion N intersecting a flange F that at least partially supports a cap CP. In other embodiments, the containers B could be beverage cans or another suitable type and size of container.

Referring again to FIGS. 15 and 16, the system 300 can have an upstream end 303 and a downstream end 305 and a machine direction M generally extending from the upstream end 303 to the downstream end 305. As described further herein, a linear product path P along which containers B are carried through the system 300 can be parallel to the machine direction M. In this regard, the containers B can be supported on and carried on a product conveyor, e.g., a conveyor that includes one or more of belts, treads, chains, flights, lugs, etc. to carry one or more of the containers B along the product path P that can be generally in the machine direction M, though portions of the system 300 above the product path P may be obliquely or curvedly arranged relative thereto, as described further herein.

In some embodiments, the containers B can be received from an upstream product grouping station or associated apparatus. In other embodiments, the containers B can enter the system 300 in a desired grouping. Such groupings can include row and column arrangements of containers B, for example, that correspond to row and column arrangements of the container openings 43 of the blank 37 to which the groups of containers B can be attached.

The system 300 can include a blank infeed assembly 307 proximate the upstream end 303 thereof for receiving and sequentially distributing blanks 37 in the machine direction M of the system 300. Accordingly, the system 300 can include a feeder mechanism such as a hopper, chute, or other in-line or right-angle distribution mechanism.

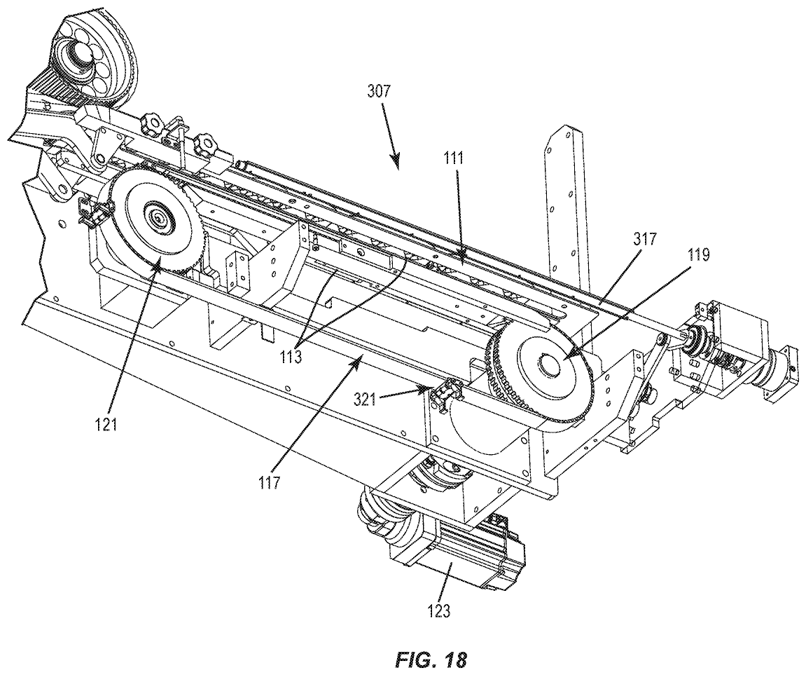

With additional reference to FIGS. 17 and 18, the blank infeed assembly 307 can include a generally vertical support 309 upon which the bedplate 111 with generally parallel slots 113 is mounted. The slots 113 are positioned to at least partially receive generally upright/upstanding portions of lug assemblies that are attached/coupled to the drive belt 117 looped around the first roller 119 and the second roller 121, as described further herein.

A pair of guide rails 317 can be positioned extending generally parallel to and above the bedplate 111 in the machine direction M. Each guide rail 317 can be a generally elongate member that supports a blank guide 319 thereupon, the blank guides 319, optionally, for contacting and or maintaining a position of the blanks 37 on the bedplate 111.

In this regard, one guide rail 317 can be coupled to a motor 123 and configured for rotation upon activation of the motor 123, e.g., via an intermediate transmission such as a gearbox/gearing, etc., and a linkage 320 can mechanically couple the guide rail 317 associated with the motor 123 to the other guide rail 317. As described further herein, the linkage 320 can cause the motor-driven guide rail 317 to transmit such rotational motion through the linkage 320 to the other guide rail 317 such that the other guide rail 317 rotates in an opposite direction about an axis parallel to the machine direction M relative to the motor-driven guide rail 317. In this regard, the linkage 320 can include one or more links and rotational couplings.

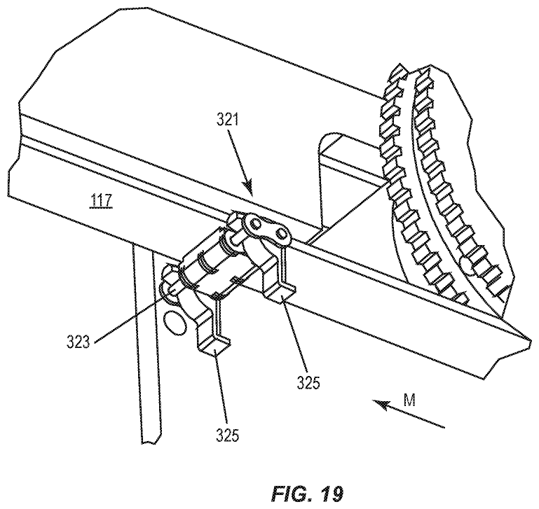

Referring additionally to FIG. 19, the drive belt 117 can support a plurality of spaced apart lug assemblies 321 that include a lug support 323 to which a pair of upstanding lug fingers 325 are coupled. In some embodiments, the lug supports 323 can have the configuration of a plurality, e.g., a pair, of parallel bars held together with links. In this regard, one of more of the central links can be coupled to the drive belt 117 while the lug fingers 325 are coupled to one or more of the bars of the lug supports 323. The lug fingers 325, as shown, can have a base portion coupled to the respective bar and a distal portion with a curved, hooked, angled, etc. configuration for engaging one or more of the blanks 37. In some embodiments, one or more portions of the lug assemblies 321 can have a different configuration without departing from the disclosure. In some embodiments, the various portions of the lug assemblies 321 can be adjustable relative to one another to accommodate drive belts/blanks/bedplates of different configurations.

As shown, and as described further herein, a sensor assembly 327 can be positioned along a downstream portion of the blank infeed assembly 307. The sensor assembly 327, in some embodiments, can be an optical based sensor such as a fiber optic sensor, electromagnetic beam sensor (e.g., laser), etc., for detecting the passage of one or more blanks 37 thereby.

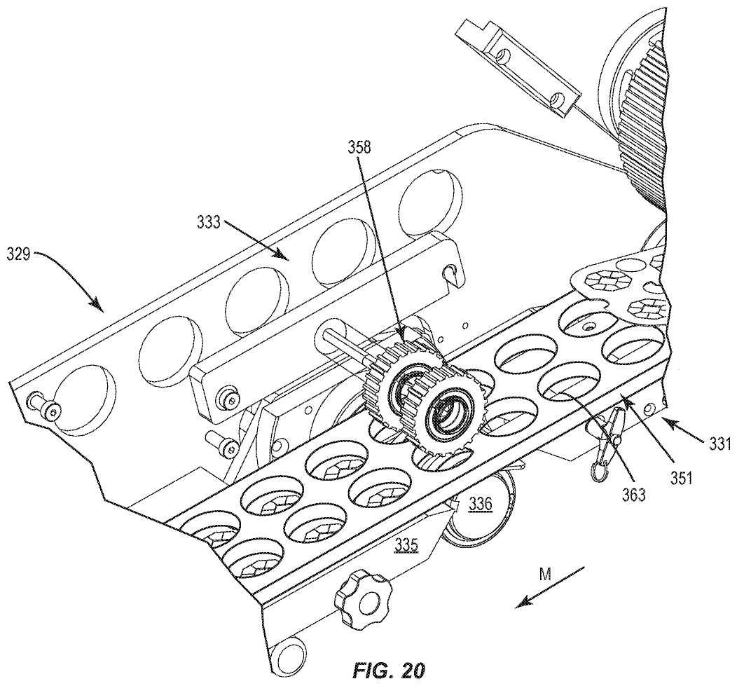

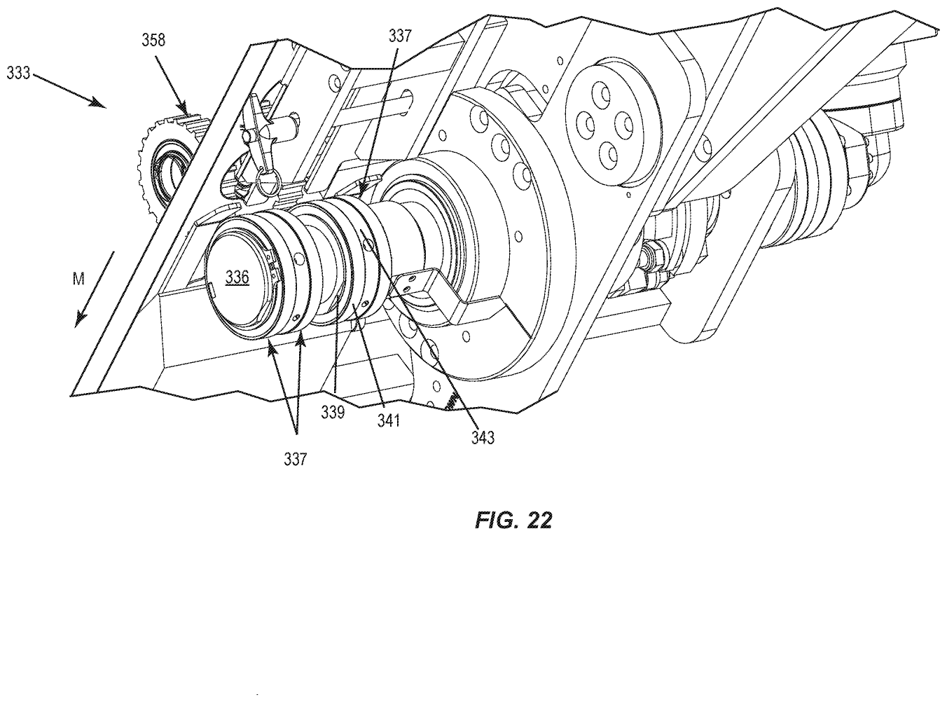

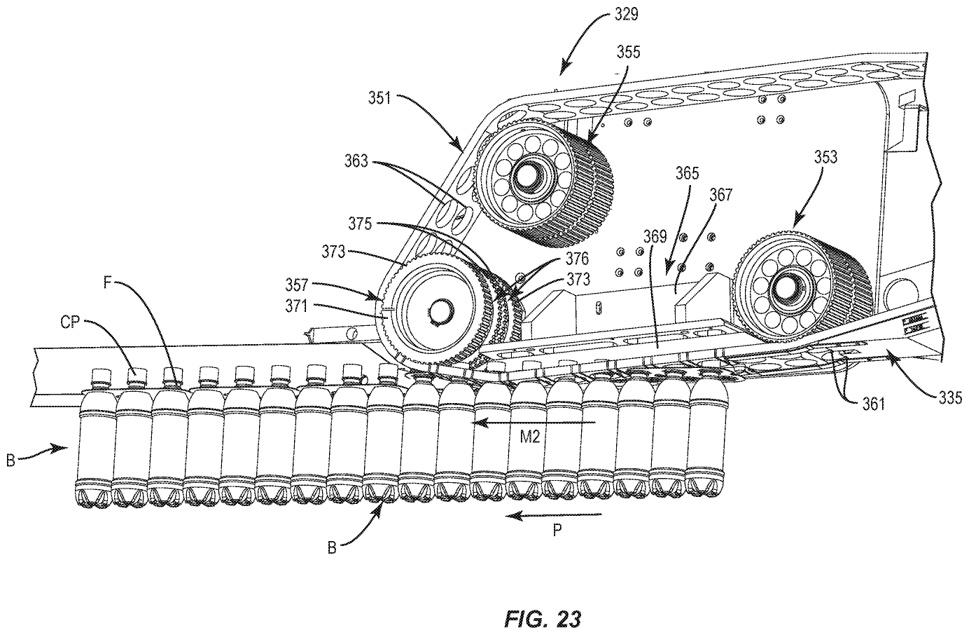

With additional reference to FIGS. 20-23, a blank processing assembly 329 can be positioned downstream from the blank infeed assembly 307 in the machine direction M. The blank processing assembly 329 can include a ramp 331 positioned adjacent/abutting a downstream end of the bedplate 111. The ramp 331, as shown, can be angled/sloped or otherwise shaped/oriented to extend further downstream in the machine direction M along the blank processing assembly 329. In the illustrated embodiment, the ramp 331 is angled downwardly from the blank infeed assembly 307 toward a nick breaking assembly 333.

The nick breaking assembly 333 can be positioned between the ramp 331 and a bedplate 335 that extends further into the blank processing assembly 329 along the machine direction M. The nick breaking assembly 333 can include a drive shaft 336 that can be coupled to a motor 123 directly or via an intermediate transmission. As described further herein, activation of the motor 123 can drive the shaft 336 to rotate.

Respective pairs of spaced bearings 337 can be coupled about the drive shaft 336. In some embodiments, the bearings 337 can be ball bearings or bearings of another configuration. In this regard, the bearings 337 can have a respective generally annular inner ring 339 fixedly coupled to the shaft 336 extending therethrough and a respective generally annular outer ring 341 rotatably mounted about the respective inner ring 339.

In some embodiments, a plurality of bearings, e.g., spheroid or other members generally configured for rolling, can be positioned in a generally annular chamber at least partially defined between the respective inner ring 339 and the respective outer ring 341 such that the respective outer ring 341 can be configured to rotate relative to the respective inner ring 341 via rolling contact with the respective bearings.

A nick support 343 (broadly “forming wheel”) can be positioned between each respective pair of bearings 337, and can be fixedly rotatably coupled to the shaft 336 so as to rotate therewith. As shown, the nick support 343 can have a body with at least one circumferential discontinuity for at least partially receiving a cutting member 349, e.g., a knife or other cutting structure, protruding at least partially therefrom. In the illustrated embodiment, each cutting member 349 can have a generally wedge-shaped configuration, though one or more cutting member 349 can have a different configuration without departing from the disclosure.

The blank processing assembly 329, as shown, can include a forming belt 351 extending around, e.g., forming an outer perimeter, about a series of rollers 352, 353, 355, 357 such that the forming belt 351 is arranged in a closed path. In some embodiments, the blank processing assembly 329 can include the nick breaking assembly 333.

As shown, a pair of sprockets 358 can be supported above an upper portion of the forming belt 351, for example, to at least partially maintain an arrangement of the forming belt 351 therebeneath.

The bedplate 335 can extend from the nick breaking assembly 335 to support the blanks 37 at least partially below the forming belt 351, and a pair of support rails 361 can extend from the bedplate 359 to further support the blanks 37 below the forming belt 351 as they move in the machine direction M. In the illustrated embodiment, the bedplate 359 and the support rails 361 can be obliquely arranged relative to one another. It will be understood that a differently-arranged blank supporting structure can extend below the forming belt 351 without departing from the disclosure.

The rollers 353, 355, 357 can have one or more features for engaging the forming belt 351, e.g., spurs, gears, spokes, treads, knurls, etc. The rollers can be configured to rotate in a common direction, e.g., counterclockwise, to cause the forming belt 351 disposed thereabout in a desired direction. While such direction can be generally in the machine direction M, at least a portion of the lower portion of the path of the forming belt 351, e.g., a lower portion of the forming belt 351 between the rollers 353, 357, can extend in a direction M2 that obliquely approaches the product path P. In some embodiments, the direction M2 can be a direction that is obliquely oriented to intersect the product path P.

The forming belt 351, as shown, can be a generally flat member formed of a body having a plurality of openings 363 at least partially defined therethrough. The forming belt 351 can be formed of a material suitable to withstand applied tension and/or engagement with the respective rollers 353, 355, 357. In one embodiment, the forming belt 351 can include one or more of polymeric materials, composite materials, and metallic materials. In one embodiment, the forming belt 351 can include one or more reinforcing members, e.g., embedded structures, binders, braids, etc. In some embodiments, the forming belt 351 can have a stress rating of about 957 N/mm or 857 inch-pounds to facilitate such at least partial receipt of the containers B and the associated driving forces produced by the system 300.

As described further herein, the openings 363 in the forming belt 351 can be formed in with a diameter/arrangement corresponding to that of the combined container openings 43 and container retention tabs 45 of the blank 37. The openings 363 can extend fully through a thickness of the body of forming belt 351 for at least partially receiving a respective container B, as described further herein.

The aforementioned arrangement of the forming belt 351 is such that that when the forming belt 351 is arranged in a generally planar arrangement above a respective blank 37, respective openings 363 in the forming belt 351 can be aligned with the container openings 43 in the blank 37.

As shown, a backpressure assembly 365 can be provided in general registration with a portion of the forming belt 351 that approaches the product path P (broadly, “product engagement portion of the blank processing assembly 329”). The backpressure assembly 365, as shown, can include a frame 367 that supports one or more backpressure guides 369 that are oriented for selective contact with the forming belt 351 to facilitate coupling of a blank 37/carrier formed therefrom and a respective container B, as described further herein.

As shown, the roller 357 (broadly, “at least one roller”) can be coupled, e.g., directly or via a transmission, with a motor 123 to apply a rotational force thereto when activated, e.g., so as to cause clockwise rotation of the forming belt 351 about the rollers 353, 355, 357 from the perspective of FIG. 15.

The roller 357 can have a generally drum shaped body 371 with a pair of symmetrical halves with respective pair of outer portions 373 and inner portions 375 configured as or otherwise provided with a knurled, spurred, geared, spoked, treaded, etc., configuration, for contact with the forming belt 351. Between each outer portion 373 and each inner portion 375 is a respective recessed portion 376 circumferentially spaced away from the respective portions 373, 375.

In the illustrated embodiment, at least the roller 357 and the backpressure assembly 365 can be mounted to a vertical support 377 that can be vertically adjustable relative to the machine direction M and/or the support 309. Accordingly, in some embodiments, the vertical support 377 can be operably coupled to a lifting mechanism 379, e.g., a screw jack or other linear actuator, that is driven by a motor 123 so as to adjust at least a portion of the blank processing assembly 329 relative to the product path P.

With reference again to FIGS. 15-23, a method of preparing blanks 37 and/or attaching blanks 37/carriers formed therefrom to containers B with the system 300 according to an exemplary embodiment of the disclosure will be generally described.

One or more blanks 37 (broadly, “first blank”, “second blank”, etc.) can be loaded into the blank infeed assembly 307, e.g., via placement onto the bedplate 111 via a feeder mechanism or another mechanical or manual operation. It will be understood that the system 300 can be configured to process a series of blanks 37 joined together at respective lateral lines of weakening. Such input of multiple successive blanks 37 into the system 300 can streamline loading operations, reduce alignment errors, etc.

It will be understood that, optionally, the motor 123 associated with the guide rail(s) 317 can be activated to cause movement of each blank guide 319 (either directly or via the linkage 320) relative to the bedplate 111 to a desired orientation, e.g., so as for contacting respective blanks 37 passing therealong or for providing a maximum degree of movement for such blanks 37 away from the bedplate 111.

As each blank 37 reaches a generally planar engagement with the bedplate 111, e.g., so that an interior or downward-facing surface of the blank 37 is in at least partial face-to-face contact with the bedplate 111, the motor 123 associated with the roller 119 can be activated to cause the drive belt 117 arranged about the rollers 119, 121 to rotate in a counterclockwise direction (from the perspective of FIG. 19) to carry the lug assemblies 321 coupled thereto in the machine direction M along an upper portion thereof.

In particular, the lug fingers 325 extending upwardly form the respective lug assemblies 321 can be at least partially received through the respective slot 113 in the bedplate 111. As the lug fingers 325 advance in the machine direction M, they can be at least partially received through respective container openings 43 of the respective blanks 37 or through another notched or recessed edge along the respective blanks 37 to cause the blanks 37 to slidably move along the bedplate 111 in the machine direction M to the nick breaking assembly 333 and further downstream portions of the system 300.

In some embodiments, the motor 123 associated with the blank infeed assembly 307 can be a servomotor, e.g., a motor associated with a suitable controller that allows for precise control of one or more of position, velocity, and acceleration thereof to cause the blanks 37 to advance along the blank infeed assembly 307 at a desired rate, timing, etc.

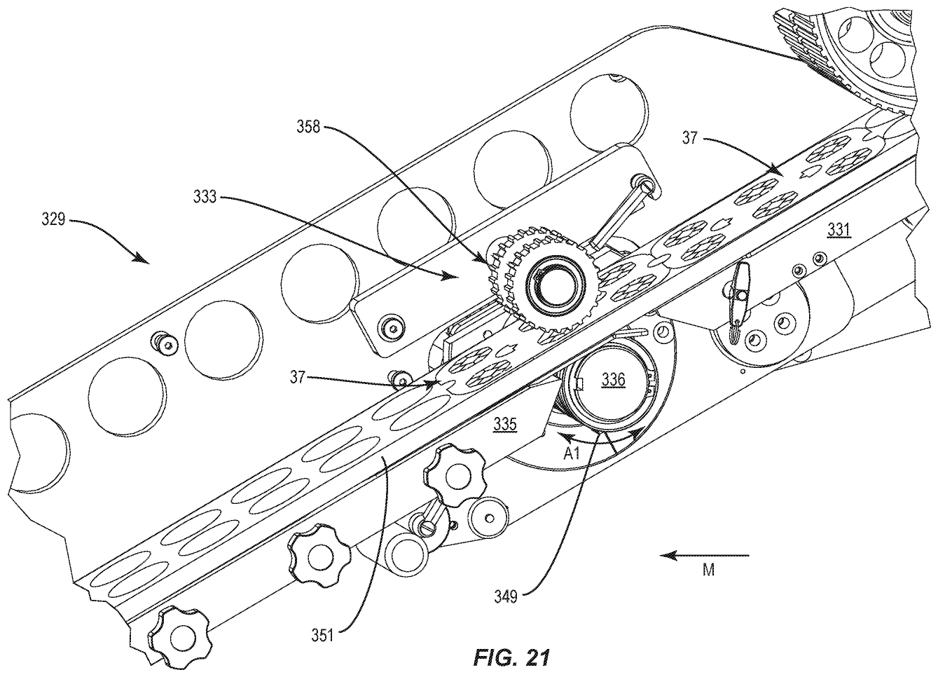

The motor 123 associated with the nick breaking assembly 333 can be activated to cause rotation of the drive shaft 336, the inner rings 339 of the respective bearings 337, and the nick supports 343. In this regard, the nick supports 343 can rotate to cause the cutting members 349 supported thereon to rotate into a position along the path of movement of the blanks 37 in the machine direction M, as indicated by the bidirectional arrow A1 in FIG. 21.

Accordingly, the cutting members 349 can be rotated into cutting engagement with one or more lines of weakening that attach successive blanks 37 to one another to effect separation thereof. In this regard, rotation of the nick breaking assembly 333 can be synchronized relative to the position of the blanks 37 moving thereupon.

For example, in some embodiments, the motor 123 associated with the nick breaking assembly 333 can be a servomotor at least partially controlled by a controller that receives one or more signals from the sensor assembly 327 of the blank infeed assembly 307. In some embodiments, the sensor assembly 327 can generate a positional signal upon a respective blank 37 passing thereby (e.g., so as to interrupt an electromagnetic beam or otherwise actuate the sensor assembly 327) that can cause the motor 123 of the nick breaking assembly 333 to rotate the drive shaft 336 such that the cutting members 349 are rotated between successive blanks 37 as they pass thereby to effect separation thereof. In some embodiments, such controller can include or be associated with one or more processor in communication having a memory (e.g., a non-volatile data storage medium) storing one or more instructions for implementation by the processor(s).

The blanks 37 can be at least partially supported on the outer rings of the bearings 337, which can rotate about the associated bearings and inner rings 339 to facilitate movement of the blanks 37 in the machine direction M toward/onto the ramp 331 of the blank processing assembly 329.

The motor 123 associated with the roller 357 of the blank processing assembly 329 can be actuated to cause counterclockwise rotation of the roller 357 and of the forming belt 351 about the rollers 353, 355, 357. The blank processing assembly 329 can be positioned relative to the ramp 331 and bedplate 359 so as to contact the respective blanks 37 and cause slidable movement therealong in the machine direction M. In this regard, optionally, the motor 123 associated with the lifting mechanism 379 can be activated to cause the vertical support 377 move relative to the ramp 331/bedplate 359 to effect such engagement of the blanks 37 by the forming belt 351.

As described above, the blanks 37 can be moved into the blank processing assembly 329 such that the openings 363 in the forming belt are generally aligned with the respective container openings 45 and container tabs 47 of the blanks 37.

As the blanks 37 are carried toward an intersection with the product path P of the containers B, the blanks 37 can be positioned so as to receive at least the cap CP, flange F, and a respective portion of the neck of the respective containers B through the respective container openings 43.

Further alignment of the forming belt 351 with the product path P can cause the cap CP and flange F of the respective containers B to be at least partially received in the openings 363 in the forming belt 351 that are aligned with the respective container openings 43 of the respective blanks 37. In some embodiments, the cap CP and, optionally, flange F of a respective container B can travel entirely through a respective opening 363 in the forming belt 351.

As the necks N and, optionally, lower portions of the respective containers B intersect the respective container openings 43 of the respective blanks 37, they can contact the respective container retention tabs 45 and cause at least partial folding thereof relative to the top panel 41 at the respective fold lines 47, 49, 51 to cause the respective container retention tabs 45 to extend obliquely upwardly from the top panel 41 to the respective flange F of a respective container B, e.g., in a bracing relationship that secures the containers B to the respective blanks 37/carriers formed therefrom.

Such engagement of the blanks 37 and the containers B can be facilitated by the positioning of the backpressure assembly 365, which can present the backpressure guides 369 proximate the top panel 41 of the respective blanks 37 between the upper portions of the respective containers B to provide a surface against which the top panel 41 can be pressed in the course of the relative movement of the blanks 37, containers B, and portions thereof as described above.

It will be understood that the coupled blanks 37/carriers formed therefrom and containers B can be considered packages or product packages.

As the blanks 37 coupled to the containers B continue along the bedplate 335 and approach the roller 357, the caps CP and, optionally, the flanges F and neck portions N of the respective containers B can be at least partially received in the central portions 376 of the body 371 of the roller 357 between the respective portions 373, 375 thereof. Such an arrangement permits a close engagement of the roller 357/portion of the forming belt 351 disposed thereabout without interfering with the passage of the containers B protruding upwardly from the blanks 37/carriers formed therefrom.

The system 300 thus provides multiple streamlined operations to prepare the blanks 37/couple the blanks 37 to containers B as described above, with advantages and functionality similar to that described above with respect to the systems 100, 200.

It will be understood that one or more of the components of the systems described herein can have a different configuration without departing from the disclosure. It will be further understood that suitable supporting structures (e.g., bases, legs, platforms, supports, braces, etc.) can be provided to support and facilitate operation of the various components described herein.

In general, the blanks of the present disclosure may be constructed from paperboard having a caliper so that it is heavier and more rigid than ordinary paper. The blank can also be constructed of other materials, such as cardboard, or any other material having properties suitable for enabling the construct to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A method for processing at least one blank for forming a carrier for a plurality of containers, the method comprising:
obtaining at least one blank comprising a central panel having plurality of container openings and at least one container retention tab extending into respective container openings of the plurality of container openings;
loading the at least one blank into a blank infeed assembly;
moving the at least one blank from the infeed assembly to a blank processing assembly, the blank processing assembly comprising a forming belt having a plurality of openings extending at least partially therethrough for being aligned with respective container openings of the plurality of containers openings of the at least one blank; and
moving the at least one blank to a product engagement portion of the blank processing assembly such that the at least one blank is positioned for engagement with a group of containers.

2. The method of claim 1, further comprising aligning a plurality of openings of the forming belt with respective container openings of the at least one blank.

3. The method of claim 2, wherein the forming belt comprises a body arranged about a closed path, the forming belt defining the plurality of openings extending fully through the body.

4. The method of claim 2, wherein the blank processing assembly is supported above a linear product path, the forming belt has a lower portion facing the linear product path, and the lower portion of the forming belt is obliquely arranged relative to the linear product path.

5. The method of claim 2, wherein the forming belt extends around a plurality of rollers for facilitating rotation of the forming belt, at least one roller of the plurality of rollers at least partially defines a recess for at least partially receiving a respective container of the plurality of containers.

6. The method of claim 5, wherein the at least one roller comprises at least one outer portion and at least one inner portion, the recess at least partially defined between the at least one outer portion and the at least one inner portion of the at least one roller.

7. The method of claim 5, further comprising rotating the at least one roller of the plurality of rollers to rotate the forming belt to align a plurality of openings of the forming belt with respective container openings of the at least one blank.

8. The method of claim 7, wherein the at least one blank is a first blank, the method further comprises a second blank attached to the first blank, and the method further comprises moving the first blank and the second blank along a nick breaking assembly and at least partially separating the first blank from the second blank.

9. The method of claim 8, wherein the nick breaking assembly comprises a nick support supporting at least one nick support to position the at least one cutting member to separate the first blank from the second blank.

10. A system for processing at least one blank for forming a carrier for a plurality of containers, the system comprising:
an upstream end, a downstream end, and a machine direction extending from the upstream end to the downstream end;
a blank infeed assembly for moving the at least one blank in the machine direction; and
a blank processing assembly, the blank processing assembly comprising a forming belt arranged in a closed path and having a plurality of openings extending at least partially therethrough for being aligned with a respective container opening of a plurality of containers openings of the at least one blank,
the blank processing assembly comprising a product engagement portion for being positioned above a group of containers for at least partially receiving a respective container of the plurality of containers through a respective opening of the plurality of container openings of the at least one blank aligned with a respective opening of the plurality of openings of the forming belt.

11. The system of claim 10, wherein the forming belt comprises a body arranged about a closed path, the forming belt defining the plurality of openings extending fully through the body.

12. The system of claim 10, wherein the blank processing assembly is supported above a linear product path, the forming belt has a lower portion facing the linear product path, and the lower portion of the forming belt is obliquely arranged relative to the linear product path.

13. The system of claim 12, wherein the forming belt extends around a plurality of rollers for facilitating rotation of the forming belt, at least one roller of the plurality of rollers at least partially defines a recess for at least partially receiving a respective container of the plurality of containers.

14. The system of claim 13, wherein the at least one roller comprises at least one outer portion and at least one inner portion, the recess at least partially defined between the at least one outer portion and the at least one inner portion of the at least one roller.

15. The system of claim 13, further comprising the at least one blank, wherein the at least one blank is a first blank and the system further comprises a second blank, and the system further comprises a nick breaking assembly for at least partially separating the first blank from the second blank.

16. The system of claim 15, wherein the nick breaking assembly comprises a nick support supporting at least one nick support to position the at least one cutting member for separating the first blank from the second blank.

17. A blank processing assembly for processing at least one blank for forming a carrier for a plurality of containers, the blank processing assembly comprising:
a forming belt arranged in a closed path and having a plurality of openings extending at least partially therethrough for being aligned with a respective container opening of a plurality of containers openings of the at least one blank,
the blank processing assembly comprising a product engagement portion for being positioned above a group of containers for at least partially receiving a respective container of the plurality of containers through a respective opening of the plurality of container openings of the at least one blank aligned with a respective opening of the plurality of openings of the forming belt.

18. The blank processing assembly of claim 17, wherein the forming belt comprises a body arranged about a closed path, the forming belt defining the plurality of openings extending fully through the body.

19. The blank processing assembly of claim 18, wherein the blank processing assembly is supported above a linear product path, the forming belt has a lower portion facing the linear product path, and the lower portion of the forming belt is obliquely arranged relative to the linear product path.

20. The blank processing assembly of claim 19, wherein the forming belt extends around a plurality of rollers for facilitating rotation of the forming belt, at least one roller of the plurality of rollers at least partially defines a recess for at least partially receiving a respective container of the plurality of containers.

21. The blank processing assembly of claim 20, wherein the at least one roller comprises at least one outer portion and at least one inner portion, the recess at least partially defined between the at least one outer portion and the at least one inner portion of the at least one roller.
